(19) United States
(12) Patent Application Publication
(10) Pub. No.: US 2005/0057872 A1
(43) Pub. Date: Mar. 17, 2005

(54) Integrated circuit voltage excursion protection

(75) Inventors: Jian-Hsing Lee, Hsin-Chu (TW); Yi-Hsun Wu, Hsin-Chu (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.

(21) Appl. No.: 10/661,895

(22) Filed: Sep. 11, 2003

(51) Int. Cl. H02H 3/00

(52) U.S. Cl. 361/90

(57) ABSTRACT

An integrated circuit voltage excursion protection apparatus and method are disclosed for sensing voltage excursions at points on the integrated circuit and utilizes the output drivers of the I/O section of the integrated circuit to dissipate charge from such events. The apparatus may be used alone or in conjunction with other conventional dissipation apparatus.

### TECHNICAL FIELD

The present invention is generally related to integrated circuits. More particularly, the invention relates to apparatus for protecting integrated circuits against the effects of voltage excursions including transient electrical discharges.

### BACKGROUND OF THE INVENTION

It is well known that high-voltage electrical transients when discharged through a silicon device can cause irreparable harm to the device. Transients can occur at anytime in a product's cycle of manufacturing, testing, assembly, field handling and service.

Many electronic devices are acutely susceptible to damage at voltages as low as 10 volts. Many sources of voltage excursions and transients exist, among them are ancillary circuitry inductive effects, poor power quality control, inadequate circuit isolation, circuit board design, lightning strikes and electrostatic discharges (ESD). The detrimental effect of many of these events can be minimized through appropriate measures designed to minimize the likelihood of and prevent the occurrence of certain transients in the first place. For example, a well-designed circuit board layout will reduce loop areas, have substantial ground planes and locate sensitive electronic components away from potential transient sources (transformers, coils, etc.). As another example, production handling methods can greatly reduce the risk of triboelectric charge build-up and discharge through the device. However, it is not possible to completely eliminnate all causes of voltage excursions that a device may encounter.

Complimentary metal oxide semiconductor (CMOS) transistor circuits are very susceptible to voltage excursion damage. The combination of very thin gate oxides and short channel lengths makes voltage excursions a particularly acute problem in high-density CMOS applications.

Widely used techniques to address such events in CMOS applications includes chip-level designs intended to control the dissipation of charge in the event of such transients. Critical points on an integrated circuit, particularly inputs, outputs and voltage rails, may be protected by various clamp, dissipation and suppression devices such as voltage-clamping diodes, silicon controlled rectifiers (SCR), and so-called dummy transistors.

Due to its high current handling capability, very low turn-on impedance, low power dissipation, and large physical volume for heat dissipation, lateral SCR devices have been recognized in the art as one of the most effective elements in CMOS on-chip protection circuits. However, reductions in diffusion junction depth and use of lightly-doped drain/salicide common in deep-submicron CMOS technology reduce even further the trigger voltage required of an SCR. Poorly designed SCRs may also suffer from latch-up issues. Even with such limitations, SCRs may be utilized as a primary protection stage for many applications in conjunction with other protection components.

So-called dummy transistors (i.e. GGNMOS and GGPMOS) are also employed as part of an overall protection scheme for integrated circuits. GGPMOS and GGPMOS may be referred to generically as GGMOS. A GGPMOS is coupled between an input/output (I/O) section pad and the source voltage rail Vcc and has its gate tied to its source. Similarly, a GGNMOS is coupled between the I/O section pad and the ground rail Vss and also has its gate tied to its source. GGMOS are typically multi-finger devices comprising a plurality of tied devices as is well known in the art.

GGMOS protection may suffer from “snapback” failure wherein during a voltage excursion event of substantial magnitude the GGMOS device will break down and enter into a “snapback” mode operating as a parasitic lateral bipolar transistor. In snapback mode the GGMOS has a low resistance and will conduct a significant portions of the event current. Non-uniformities of current flow in snapback mode may result in device failure if the device triggers into a thermal runaway condition.

With multi-finger devices, the number of snapback conducting fingers is directly related to the failure point of the GGMOS due to the described runaway condition. The more fingers, the less likely it is that a failure will occur due to current damage. However, GGMOS already tend to be relatively large in layout and additional GGMOS or fingers may not be a practical solution.

Additionally, the I/O section CMOS drivers are also commonly fabricated as multi-finger devices. As such, current crowding at the fingers of the drivers has been observed during voltage excursions. Such current crowding is undesirable and may result in driver damage.

### SUMMARY OF THE INVENTION

It is recognized that there is an ongoing need to provide voltage excursion protection to integrated circuits. The need is particularly acute with respect to deep-submicron CMOS technology. The present invention meets these needs by providing voltage excursion protection having particular utility in deep-submicron CMOS applications.

It is further recognized that as integrated circuit density increases and available layout space decreases, it is desirable that voltage excursion protection not consume an inordinate amount of layout space. The present invention provides for improvements in voltage excursion protection without requiring any significant additional layout space.

In accordance with the present invention, a voltage excursion protection apparatus and method for an integrated circuit includes utilizing at least one of the existing I/O section drivers as a protection device. A pre-driver section operates to establish the state of the output driver and includes voltage excursion event detection effective to detect an undesirable voltage excursion and to establish the output driver into a predetermined event protective state when the undesirable voltage excursion is detected. Either or both of the low and high side drivers of the I/O section may be implemented as such protective devices. The protection apparatus and method may be implemented alone or in combination with dummy transistors in the I/O section. Voltage excursions may be detected or sensed in accordance with one embodiment by way of a diode string referenced to a point in the integrated circuit, including the I/O section voltage rail Vcc or ground rail Vss.

### BRIEF DESCRIPTION OF THE DRAWINGS

The present invention will now be described, by way of example, with reference to the accompanying drawings, in which:

FIG. 1 is a schematic illustration of a related art integrated circuit with particular detail of the I/O section useful in illustrating the context of the present invention;

FIG. 2 is a high-level block diagram illustrating the present invention;

FIG. 3 is a detailed block diagram illustrating a preferred embodiment of the present invention;

FIG. 4 is a circuit schematic diagram detailing the preferred for a low-side driver implementation of the present invention;

FIG. 5 is a schematic diagram of a voltage excursion event detection circuit preferred for a high-side driver implementation of the present invention; and,

FIG. 6 is a matrix illustrating various signal states of the low-side driver implementation of the present invention illustrated in FIG. 4.

### DESCRIPTION OF THE PREFERRED EMBODIMENT

Among the various Figures, repetition of reference numerals indicates the same or similar structure, elements or function. With reference first to FIG. 1, a typical integrated circuit I/O section 10 and ancillary circuitry is illustrated. I/O section 10 receives power from voltage rail 11 at a potential Vcc and ground rail 13 at a potential Vss. The I/O section 10 presently illustrated represents bi-directional I/O functionality and encompasses a single pad 19 for receiving (reading) data thereat from an external line coupled thereto (not shown) and for transmitting (writing) data to an external line coupled thereto (not shown). I/O section includes an output driver section 15 and an input buffer section 17 which are used in a mutually exclusive manner as is well known to those skilled in the art. However, it will be recognized that dedicated input and output functions may be provided for in accordance with dedicated pads and corresponding output driver sections and input buffer sections. Input buffer section 17 includes a pair of MOSFETs 21 and 23 with gates tied together and coupled to pad 19. The drains of MOSFETs 21 and 23 are coupled together and to internal circuitry 29 which includes read/write functionality and core circuitry. Output driver section 15 includes a pair of MOSFETS 25 and 27, also referred to variously as driver(s), output driver(s) low-side driver, high-side driver, and complementary MOSFET driver(s). The gates of the output driver section 15 MOSFETs 25 and 27 are coupled to driver output lines a and b from internal circuitry 29 which selectively places the MOSFETs into conductive, low-impedance, or non-conductive, high-impedance states. It is conventional practice that the conductive states of the MOSFETs 25 and 27 are mutually exclusive when data is being written to pad 19 and the non-conductive states of the MOSFETs 25 and 27 are co-existent when data is being read from pad 19. Also illustrated in FIG. 1 are various exemplary voltage excursion protection apparatus. For example, device 31 represents a Vcc to Vss clamp which may take the form of an SCR. Pad clamp section 34 comprises pad to Vcc clamp 33 and pad to Vss clamp 35, both of which may take the form of diodes or GGMOS devices. Other locations in the I/O section 10 may also have various voltage excursion protection apparatus, though not separately illustrated, as such is well known and conventionally practiced.

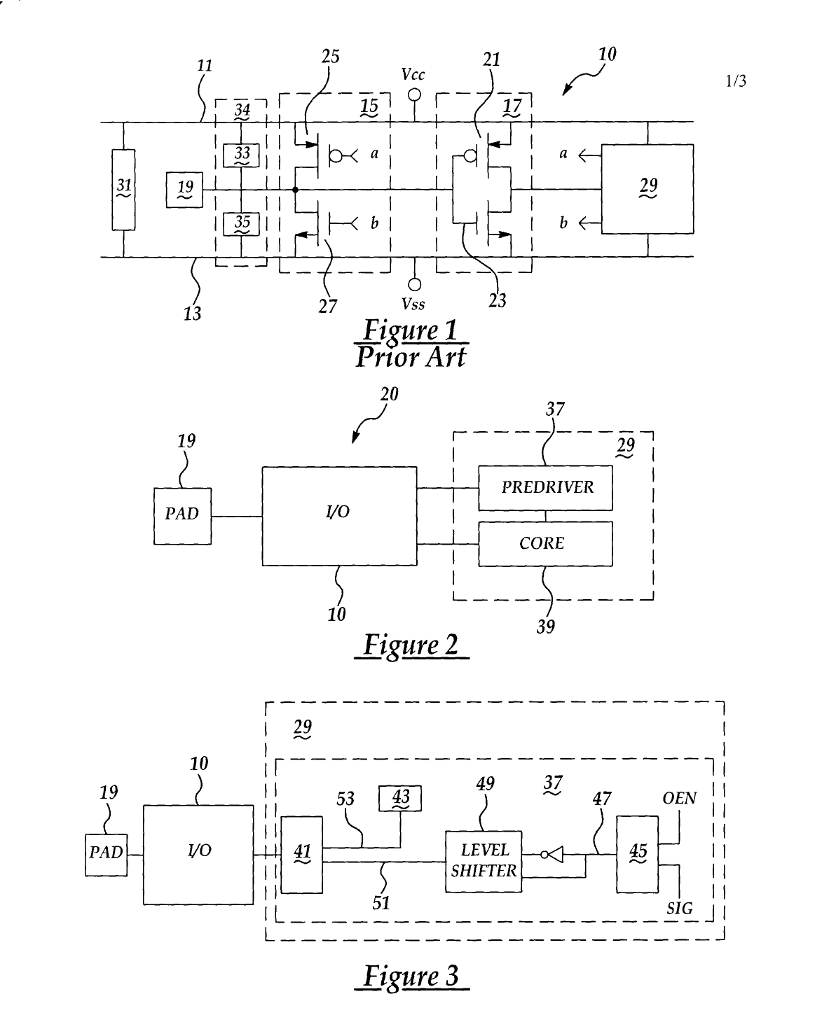

Turning now to FIG. 2, a high-level block diagram 20 illustrates the present invention. Pad 19 is shown coupled to an I/O section 10 which includes an output driver section. Internal circuitry 29 is illustrated having a pre-driver section 37 coupled to the I/O section 10 and particularly to each of the various individual drivers of the I/O section's output driver section not separately illustrated in FIG. 2. Pre-driver section may comprise separate circuit structures for each of the various one's of the individual drivers of the I/O section's output driver section, each of which may be referred to independently as a pre-driver section. Internal circuitry 29 further includes core circuitry which may include the non-limiting examples of a variety of analog and digital circuitry comprising memory, combinational logic, registers, microprocessors, digital signal processors, etc. Core circuitry 39 is illustrated as coupled to the pre-driver section 37 within the internal circuitry 29 and to the I/O section 10, particularly to the I/O section's input buffer section not separately illustrated in FIG. 2.

FIG. 3 is a detailed block diagram illustrating a preferred embodiment of the present invention with particular block diagram details of a pre-driver in accordance with the invention. The primary function of the pre-driver section 37 is, of course, to establish the states of the I/O section's output drivers. An output enable signal OEN is provided from the internal circuitry in accordance with the desired read/write state of the I/O section. Data signal SIG is also provided from the internal circuitry and represents streaming data bits desirably output to the pad 19. OEN and SIG are processed through combinational logic 45 which is essentially operative to gate data signal SIG through to line 47 when the output enable signal OEN is set to enable the data writing, else it operates to hold static line 47 in an output disabled state when the output enable signal OEN is set to disable data writing. Level shifter 49 accepts inverted and non-inverted signals from combinational logic 45 and outputs on line 51 a level shifted signal. Level shifters are used conventionally to adjust the absolute signal voltage levels of the high and/or low logic level signals necessitated by low voltage (e.g. 3.3V) operating core circuitry which interfaces (via read and write of data at the output section) with external high voltage (e.g. 5.0 V) operating circuitry. Voltage excursion event detection circuitry 43 operates to monitor and detect a voltage excursion at a predetermined point of the circuitry and provide a voltage excursion signal VE onto line 53. Voltage excursion signal VE and the level shifted signal on line 51 are both provided to combinational logic 41 which is operative to pass the level shifted signal of line 51 to the I/O section 10 when voltage excursion signal VE does not indicate a voltage excursion event. Otherwise, when a voltage excursion event is detected by circuitry 43, combinational logic 41 operates to provide a predetermined signal to I/O section 10 that establishes the driver section into a predetermined protective state. The precise combinational logic 45, 41 will be determined by the various signals at the inputs and outputs thereof. It is also understood that signal inversion may occur as signals are allowed to pass through combinational logic 45, 41 and level shifter 49 resulting in outputs at various stages that are complements of data signal inputs.

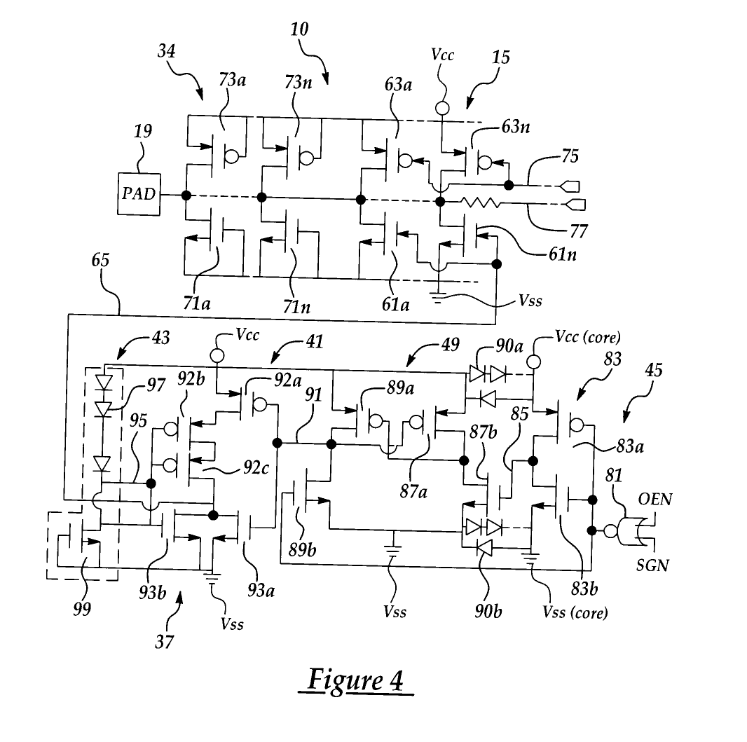

Turning now to the detailed schematic of FIG. 4, I/O section 10 is generally oriented at the top of the figure and pre-driver section 37 is generally oriented at the bottom of the figure. Pre-driver section 37 is effective to control low-side drive of output driver section 15. Specifically, MOSFETs 61ₐ through 61ₙ make up the low side driver of output driver section 15. The low side driver is illustrated as a plurality of n individual MOSFETs, however it is understood that the illustration represents multiple fingers of conventional a multi-finger MOSFET and the low side driver may hereafter be referred to in the singular with reference numeral 61. Pre-drive signal (PRE) from pre-driver section 37 is coupled via line 65 to the gate of driver 61. Line 75 is a pre-drive signal line that couples to the gate of high side driver 63 comprising a plurality of MOSFETs (fingers) 63ₐ through 63ₙ analogous to the previously described low side driver. Pre-drive line 75 similarly is coupled to a pre-driver (not shown) suitable for the establishment of the desired state of the high side driver. Also shown coupled to the common drain node between the high and low side drivers 61,63 of driver section 15 is line 77. Line 77 also couples to core circuitry (not shown) vis-a-vis an input buffer (not shown). Located to the far left in the figure of I/O section 10 is pad clamp section 34 illustrated in this example as a plurality of GGMOS transistors 73ₐ through 73ₙ and 71ₐ through 71ₙ.

Pre-driver section 37 includes combinational logic 45, level shifter 49, combinational logic 41, and voltage excursion detection circuitry 43. Beginning at the right of the pre-driver section, combinational logic 45 includes NOR gate 81 which processes the output enable signal OEN and the data signal SGN wherein a low voltage signal represents a zero logical input as is consistent throughout the remaining description. The output from NOR gate 81 couples to inverter 83 which is a conventional CMOS device comprising a pair of MOSFETS 83ₐ and 83_{b} which provide an inverted signal at line 85. The non-inverted output from two input NOR gate 81 provides a first input to level shifter 49 and the inverted output on line 85 provides a second input thereto. Level shifter comprises a pair of cross-coupled CMOS pairs 87ₐ, 87_{b} and 89ₐ, 89_{b}. Level shifter 49 is powered between Vcc and Vss rails whereas the the circuits preceding its inputs are powered between Vcc(core) and Vss(core) rails. As shown by diode groupings 90ₐ and 90_{b}, Vcc and Vss represent one set of voltage levels at the I/O section while Vcc(core) and Vss(core) represent a second set of voltage levels corresponding to the internal circuitry. The output of level shifter 49 on line 91 is a level shifted, inverted representation of the output of NOR gate 81. Combinational logic 41 is a two input NOR gate comprising three PMOSFETs 92ₐ, 92_{b} and 92_{c}, and two NMOSFETs 93ₐ, 93_{b} and the output from level shifter 41 on line 91 provides one input to NOR gate 41. The other input to NOR gate 41 is provided on line 95 which has its level set in accordance with voltage excursion detection circuitry 43. Voltage excursion detection circuitry 43 comprises a diode string 97 referenced at the terminal anode end to Vcc and at the terminal cathode end to NOR gate 41 and the drain of MOSFET 99 which has its gate and source tied to Vss to provide high resistance between the cathode terminal end of diode string 97 and Vss. The voltage detection circuitry 43 thus provides as an input to NOR gate 41 in line 95 a voltage signal that is at least one and preferably several diode drops below Vcc sufficient to ensure that at normal Vcc voltages the input on NOR gate 41 from line 95 remains below the high voltage trigger threshold of NMOSFET 93_{b} (and below the low voltage trigger threshold of PMOSFETs 92_{b} and 92_{c}) whereby NOR gate 41output on line 65 (pre-drive signal PRE) is established in accordance with the signals propagated through the prior pre-driver circuitry as the first input on line 91 to NOR gate 41. Voltage excursion events that pull Vcc higher and outside of a predetermined setpoint would result in the input on NOR gate 41 from line 95 to cross above the voltage threshold which the NOR gate 41 recognizes to establish the low-side driver into a protective state.

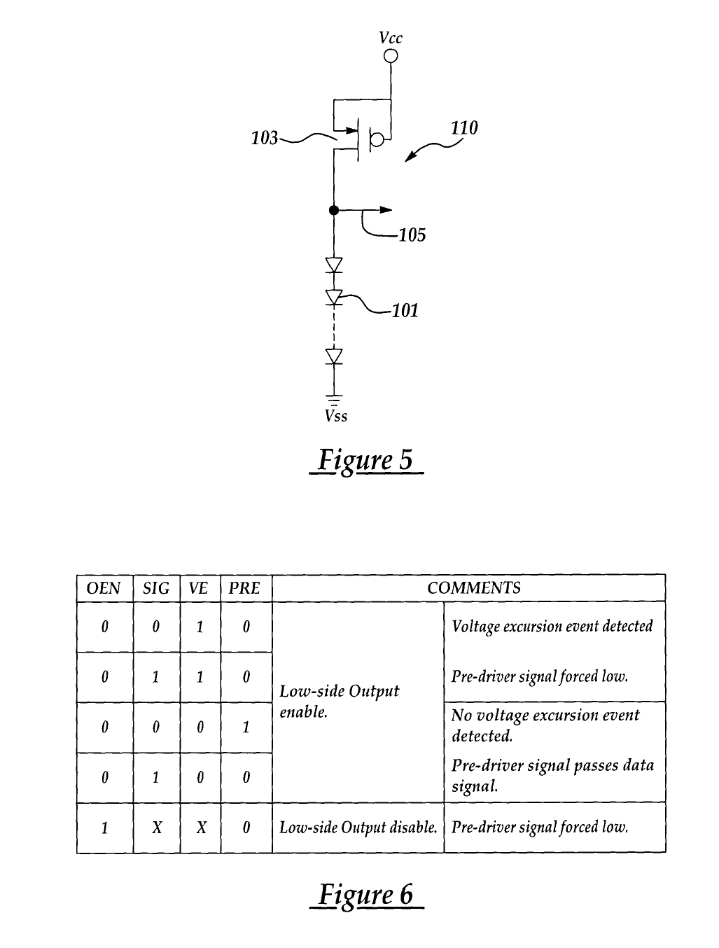

A similar pre-driver section having appropriate combinational logic for establishing the desired states of the high-side driver of output driver section 15 is not separately illustrated as such is analogous to the described pre-driver 37 of FIG. 4 and readily implemented by one having ordinary skill in the art when following the teaching contained herein. FIG. 5 is offered to illustrate a preferred and analogous voltage excursion detection circuit 110 appropriate for triggering the high-side driver into a protective state. Here, a diode string 101 is referenced at the terminal cathode end to Vss and coupled at the terminal anode end to the drain of a PMOSFET 103 which has its gate and source tied to Vcc to provide high resistance between the anode terminal end of diode string 101 and Vcc. The voltage detection circuitry 110 thus provides as an input 105 to appropriate combinational logic (not shown) that is at least one and preferably several diode drops above Vss sufficient to ensure that at normal Vss voltages the input to the combinational logic remains above a voltage threshold which the corresponding combinational logic recognizes to allow propagation of the signal data. Voltage excursion events that pull Vss lower and outside of a predetermined setpoint would result in the input 105 to the combinational logic to cross below the voltage threshold which the corresponding combinational logic recognizes to establish the high-side driver into a protective state. Such high side pre-driver section would behave similar although essentially with inverted logical operations to establish the high-side driver into the desired states.

Essentially then, both low and high-side pre-drivers would function to establish throughput of signal data SIG when the output enable signal OEN indicates that data is to be written to the output pad by complementary operation of the high and low side drivers of the output section 15. When data is not to be written, such as when data is to be read from the output pad, the output enable signal OEN would indicate such and both high and low-side drivers would be established in an off or high impedance state. If at any time the voltage excursion detection circuits 43 or 110 sense a voltage excursion event, the appropriate drivers in the output driver section 15 are established into a predetermined protective state, typically an off state.

FIG. 6 illustrates and summarizes the logical operation of the previously described embodiment of a low-side pre-driver in accordance with the present invention. At any time when the output enable signal is in a low voltage (logic zero) state, a writing of data to the I/O section is desired in accordance with the data signal SIG. The comments indicate that the low-side output is enabled; in fact, the high side output would similarly be enabled. In other words, the combinational logic 45 of FIG. 3 would allow gating or passage of the data signal SIG. At any time the voltage excursion signal VE is in a low voltage state (logic zero) indicating normal Vcc voltage, data signals propagated through the pre-driver should be allowed to pass and combinational logic 43 of FIG. 3 would allow gating or passage of the data signal SIG thereby establishing the pre-driver signal PRE in accordance with the desired state of the low-side output driver of the output driver section 15. The comments so indicate this operation. However, at any time the voltage excursion signal VE is in a high voltage state (logic 1) indicating abnormally high Vcc voltage, combinational logic 43 of FIG. 3 would establishing the pre-driver signal PRE in accordance with the desired protective state (low-side driver off) regardless of the data signal SIG state. This too is indicated in the comments. The comments indicate that the low-side output is enabled; in fact, the high side output would similarly be enabled. In other words, the combinational logic 45 of FIG. 3 would allow gating or passage of the data signal SIG. Finally, at any time when the output enable signal is in a high voltage (logic one) state, no writing of data to the I/O section is desired, no data signal is propagated through the pre-driver section and the pre-driver signal PRE is forced to a low voltage (logic 0) state thereby placing the low-side driver in an off state regardless of the logic levels of data signal SIG line and voltage excursion VE line.

The invention has been described with respect to certain preferred embodiments to be taken by way of example and not by way of limitation. Certain alternative implementations and modifications may be apparent to one exercising ordinary skill in the art. Therefore, the scope of invention as disclosed herein is to be limited only with respect to the appended claims.

The invention in which an exclusive property or privilege is claimed are defined as follows:

1. Voltage excursion protection apparatus for an integrated circuit embedded in I/O section, comprising:
an I/O section including at least one output driver; and,
a pre-driver section for establishing the state of said at least one output driver, said pre-driver section including a voltage excursion event detection circuit effective to detect an undesirable voltage excursion and to establish said at least one output driver into a predetermined event protective state when said undesirable voltage excursion is detected.

2. The voltage excursion protection apparatus as claimed in claim 1 wherein said at least one output driver is a low-side driver.

3. The voltage excursion protection apparatus as claimed in claim 1 wherein said at least one output driver is a high-side driver.

4. The voltage excursion protection apparatus as claimed in claim 1 wherein the voltage excursion event detection circuit includes a diode string referenced against a predetermined point in the integrated circuit.

5. The voltage excursion protection apparatus as claimed in claim 2 wherein the voltage excursion event detection circuit includes a diode string referenced against a predetermined point in the integrated circuit.

6. The voltage excursion protection apparatus as claimed in claim 3 wherein the voltage excursion event detection circuit includes a diode string referenced against a predetermined point in the integrated circuit.

7. The voltage excursion protection apparatus as claimed in any one of claims 1 through 6 wherein said I/O section further includes at least one dummy transistor.

8. The voltage excursion protection apparatus as claimed in any one of claims 4, 5, or 6 wherein the diode string is referenced against one of Vcc and Vss of the I/O section.

9. The voltage excursion protection apparatus as claimed in claim 7 wherein the diode string is referenced against one of Vcc and Vss of the I/O section.

10. Method for protecting an integrated circuit having an I/O section including at least one output driver against voltage excursions, comprising:
monitoring a voltage at a pretermined point in the integrated circuit;
establishing said at least one output driver into a predetermined protective state when said voltage at said predetermined point deviates from a predetermined voltage.

11. The method for protecting an integrated circuit as claimed in claim 10 wherein said at least one output driver is a MOSFET and establishing said at least one output driver into a predetermined protective state comprises establishing said MOSFET into an off state.

12. The method for protecting an integrated circuit as claimed in claim 10 wherein said at least one output driver is a low-side N-type MOSFET and establishing said at least one output driver into a predetermined protective state comprises establishing said low-side N-type MOSFET into a grounded gate state.

13. The method for protecting an integrated circuit as claimed in claim 10 wherein said at least one output driver is a high-side P-type MOSFET and establishing said at least one output driver into a predetermined protective state comprises establishing said high-side P-type MOSFET into a voltage-tied gate state.

14. Voltage excursion protection apparatus for an integrated circuit embedded in I/O section, comprising:
an I/O section including a pair of complementary MOSFET drivers; and,
a pre-driver section for establishing the state of at least one of said pair of complementary MOSFET drivers, said pre-driver section including a voltage excursion event detection circuit effective to detect an undesirable voltage excursion and to establish said at least one of said pair of complementary MOSFET drivers into an off state when said undesirable voltage excursion is detected.

15. The voltage excursion protection apparatus as claimed in any one of claims 14 wherein the voltage excursion event detection circuit includes a diode string referenced against a predetermined point in the integrated circuit.

16. The voltage excursion protection apparatus as claimed in claim 14 wherein said I/O section further includes at least one pair of dummy complementary MOSFETs.

17. The voltage excursion protection apparatus as claimed in claim 15 wherein said I/O section further includes at least one pair of dummy complementary MOSFETs.

18. The voltage excursion protection apparatus as claimed in any one of claims claim 15 through 17 wherein the diode string is referenced against one of Vcc and Vss of the I/O section.
